(19) United States
(12) Patent Application Publication
(10) Pub. No.: US 2006/0057061 A1
(43) Pub. Date: Mar. 16, 2006

(54) Determination of the hydrogen storage capacity of novel sepiolite-derived carbonaceous materials

(75) Inventors: Giselle Sandi-Tapia, Glen Ellyn, IL (US); Kathleen Carrado Gregar, Naperville, IL (US)

Correspondence Address: HARRY M. LEVY, ESQ.;EMRICH & DITHMAR, LLC., Suite 2080, 125 South Wacker Drive, Chicago, IL, 60606, US

(73) Assignee: THE UNIVERSITY OF CHICAGO, Chicago, IL (US)

(21) Appl. No.: 11/088,606

(22) Filed: Mar. 23, 2005

Related U.S. Application Data
(60) Provisional application No. 60/565,915, filed on Apr. 28, 2004.

(51) Int. Cl. B32B 9/00; C01B 3/08

(52) U.S. Cl. 423/658.2; 428/408

(57) ABSTRACT

Carbonaceous nanofibers derived from a one dimensional channeled material having hydrogen adsorbed on the surfaces thereof are disclosed as a well as a method of storing hydrogen in which a plurality of carbonaceous nanofibers derived from a one dimensional channeled material are provided, and the nanofibers are contacted with hydrogen at a temperature and pressure for a time sufficient to adsorb hydrogen thereon.

### RELATED APPLICATION

This application claims priority from U.S. Provisional Application Ser. No. 60/384,757, Filed May 30, 2002.

### CONTRACTUAL ORIGIN OF THE INVENTION

The United States Government has rights in this invention pursuant to Contract No. W-31-109-ENG-38 between the U.S. Department of Energy and The University of Chicago representing Argonne National Laboratory.

### FIELD OF THE INVENTION

This invention relates to apparatus and methods of storing hydrogen for subsequent use, particularly in vehicles.

### BACKGROUND OF THE INVENTION

Interest in hydrogen as a fuel has grown dramatically since 1990, and many advances in hydrogen production and utilization technologies have been made. However, hydrogen storage technologies must be significantly advanced if a hydrogen based energy system, particularly in the transportation sector, is to be established. Hydrogen can be made available on-board vehicles in containers of compressed or liquefied H₂, in metal hydrides, via chemical storage or by gason-solid adsorption. Although each method possesses desirable characteristics, no approach satisfies all of the efficiency, size, weight, cost, and safety requirements for transportation or utility use.

Gas-on-solid adsorption is an inherently safe and potentially high energy density hydrogen storage method that could be extremely energy efficient. Consequently, the hydrogen storage properties of high surface area activated carbons have been extensively studied as set forth in “Determination of the Hydrogen Storage Capacity of Novel Sepiolite-Derived Carbonaceous Materials” published June, 2003, Journal of New Materials for Electrochemical Materials,” the entire disclosure of which is incorporated herein.

However, activated carbons are ineffective in storing hydrogen because only a small fraction of the pores in the typically wide pore size distribution are small enough to interact strongly with hydrogen molecules at room temperatures and moderate pressures. While many new carbon nanostructured adsorbents have been produced, including graphite nanofibers, carbon multi-wall, and single-wall nanotubes, most of these materials are synthesized using very long and costly procedures.

### SUMMARY OF THE INVENTION

Accordingly, a principal object of the present invention is to provide carbon nanofibers which are easily fabricated and which absorb a significant amount of hydrogen are stable at ambient temperatures as well as those temperatures encountered in ordinary vehicle usage.

Another object of the present invention is to provide carbonaceous nanofibers derived from a one dimensional channeled material having hydrogen adsorbed on the surfaces thereof.

Yet another object of the present invention is to provide a method of storing hydrogen, comprising providing a plurality of carbonaceous nanofibers derived from a one dimensional channeled material, and contacting the nanofibers with hydrogen at a temperature and pressure for a time sufficient to adsorb hydrogen thereon.

### BRIEF DESCRIPTION OF THE DRAWINGS

The invention consists of certain novel features and a combination of parts hereinafter fully described, illustrated in the accompanying drawings, and particularly pointed out in the appended claims, it being understood that various changes in the details may be made without departing from the spirit, or sacrificing any of the advantages of the present invention.

FIG. 1 is a schematic representation of sepiolite clay;

FIG. 2 is a schematic representation of imogolite clay;

FIG. 3 is a schematic diagram of the hydrogen storage measuring setup;

FIG. 4 is a TEM of carbon obtained after removal of the template;

FIG. 5 is a TEM of sepiolite clay;

FIG. 6 is a TEM of a sepiolite/propylene composite;

FIG. 7 is a TEM of carbon obtained after removal of the template;

FIG. 8 is a HRTEM of carbon obtained after removal of the template;

FIG. 9 is a graphical representation of a pressure transition of the “fraction 3” sample after H₂ introduction into the reaction chamber; and

FIG. 10 is a graphical representation of the H₂ absorbed in weight % for “fraction 3” sample versus the adsorption time.

### DETAILED DESCRIPTION OF THE INVENTION

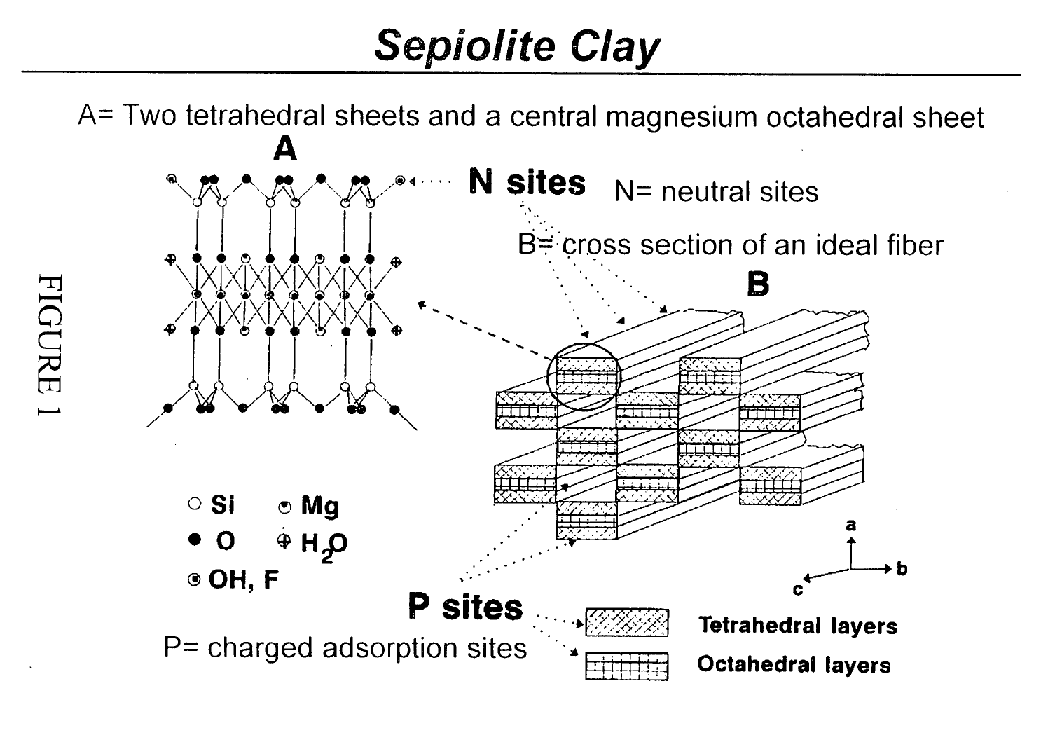

Sepiolite clay has been used as an inorganic template to load organic precursors and obtain carbonaceous materials. As seen in FIG. 1, sepiolite has fibers of 0.2 to 2 μm in length, 100×300 Å in width and a thickness of 50 to 100 Å. The fibrous structure is composed of ribbons with two sheets of tetrahedral silica units, linked by oxygen atoms to a central octahedral sheet of magnesium so that the tetrahedral sheet of silicon is continuous, but with the directions of the apical extremes of the tetrahedral sheets of silica inverted after every six tetrahedral units. This spatial configuration determines the presence of channels oriented in the longitudinal direction of the fibers. The cross-section of these channels is 3.6 Å×10.6 Å. The channels are suitable for controlling the structure of organic compounds. It has been suggested that the strong Brønsted acidity due to bound water in sepiolite makes possible the polymerization initiation of isoprene at room temperature. Others have polymerized pyrrole in the intracrystalline tunnels of sepiolite in the presence of halogen molecules in order to prepare a conducting composite with electrical conductivity and ordered structure.

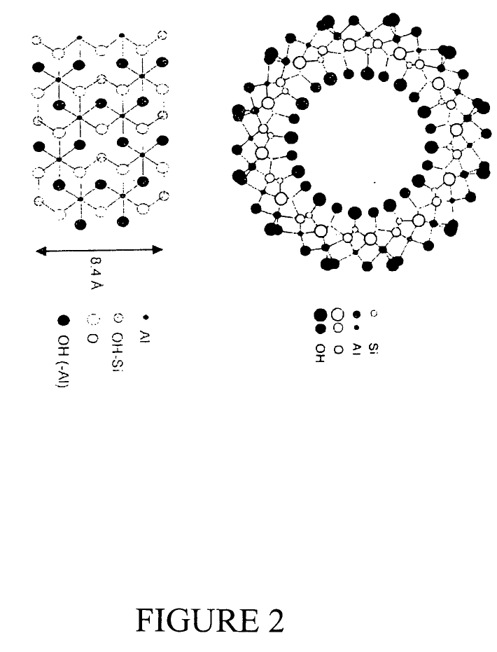

In this invention, we synthesized carbonaceous materials that are derived from ethylene or propylene upon incorporation in the vapor phase in the channels of sepiolite, taking advantage of the strong Brønsted acidity in the channels to polymerize olefins. Although sepiolite has been used in the preferred embodiment of this invention, other materials are included, both naturally occurring and synthetic. Other naturally occurring materials include imogolite clay, see FIG. 2, as well as another one dimensional clay, polygorskite. All of these channeled clays have acidic sites interior of their channels to facilitate the polymerization of hydrocarbon vapors. Various synthetic one dimensional materials are included in the invention, such as, but not limited to, zeolites including aluminosilicates or an aluminophosphates or a magnesium silicates or phosphates. All of these natural and synthetic materials may be used alone or in combination.

Additional details about the synthesis of carbon derived from sepiolite are set forth in U.S. Pat. No. 6,110,621; G. Sandí, K. A. Carrado et al, J. Electrochem. and G. Sandí et al. J. New Mat. Electrochem Systs 6, the disclosures of each being incorporated by reference.

Italian sepiolite samples were obtained from Technology for Requalification and Microseparation of Materials (TRM), Viale Venezia 170, 25123 Brescia-Italy. Five types of sepiolite samples were used as carbon templates: “raw material”, “fraction 1”, “fraction 2”, “fraction 3”, and “fraction 4”. Raw material is the type of sepiolite that they receive and process in their plant. The plant has a pneumatic conveyor, which can micronize and divide an input powder into two to four fractions through a special mechanic system. The mechanical system is composed of a crashing micronizer, 2 cyclonic separators (each of them provided with a decantation valve at the bottom), one powder decantation cyclone, and one sleeve air-filter. All these elements are put on line. The separation is obtained by difference of granulometric size and/or density of the particles (in this case only granulometric size, since the material was homogeneous). Fraction 1 is composed by the heaviest and most dense particles decanted by the first separator, fraction 2 or intermediate decanted by the second separator, fraction 3 or light decanted by the cyclone, and fraction 4 or extra-light decanted through the air-filter. It is then assumed that particles of fraction 1 have a larger average granulometric size than fraction 2, while fractions 3 and 4 will have smaller granulometric size. The Spanish sepiolite we obtained from Yunclillos (Toledo, Spain), provided by TOLSA, S. A, see Table 1.

TABLE 1
Gravimetric storage capacity (weight %)
of H₂ on Carbon Nanofiber Samples

| Sample Description | Gravimetric storage capacity, % |
|---|---|
| Spanish | 1.08 |
| Italian Raw | 2.76 |
| 1^{st} Fraction | 2.17 |
| 2^{nd} Fraction | 4.42 |
| 3^{rd} Fraction | 1.82 |
| 4^{th} Fraction | 2.24 |

297 K and 10 MPa

Ethylene or propylene were loaded and pyrolyzed in the gas phase in one step using a three-zone furnace. Quartz boats containing sepiolite were placed within a quartz tube. The temperature of the oven was gradually increased from room temperature to 700° C. The oven was then held at that target temperature for 4 hours. The clay from the loaded/pyrolyzed sepiolite sample was removed using HF, rinsed to neutral pH, and refluxed with concentrated HCl for 2 hours. The sample was washed with distilled water until the pH was >5 to ensure that there was no acid left. The resultant carbon was oven dried overnight at 120° C.

X-ray powder diffraction (XRD) patterns of sepiolite, sepiolite/organic composites and carbons were determined using a Rigaku Miniflex, with Cu Ká radiation and a Nal detector at a scan rate of 0.5°2Θ/min.

Thermal gravimetric analysis (TGA) was carried out on SDT 2960 simultaneous DTA TGA using a nitrogen flow of 100 mL/min at a scan rate of 10° C./min; some measurements were done in oxygen as well.

Transmission electron microscopy (TEM) was performed in a JEOL 400CXII Transmission Electron Microscope operating at 100 kV. Approximately 0.01 g of the powder sample was placed into a vial containing about 10 ml of methanol. After sonicating for 30 seconds, copper grids with “holey” carbon films were then dipped into the resulting slurry. The Cu grids were allowed to dry for 2 hours in a vacuum oven at 100° C. Once dry, the grids were inserted into non-tilt holders and loaded into the instrument. Only regions overhanging holes in the carbon grid were used. Scale markers placed on the micrographs are accurate to within three percent.

The N₂ BET surface area and pore size distribution of the resulting carbon was performed using a Micromeritics ASAP 2010.

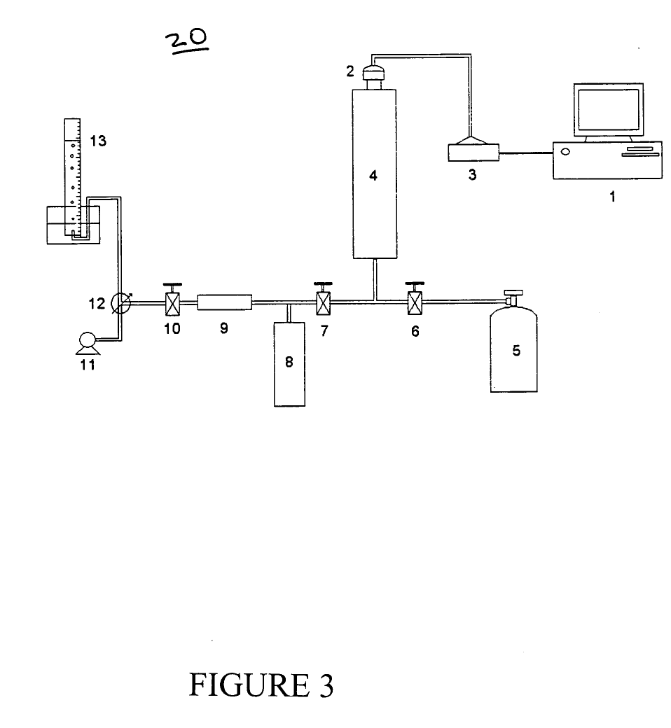

FIG. 3 shows the schematic diagram of the hydrogen storage setup 20 which comprises a personal computer for the calculations 1 connected to a multi-meter 3. The multi-meter is connected to a hydrogen reservoir 4 through a pressure transducer 2. The hydrogen reservoir 4 is connected to a hydrogen cylinder 5 through a valve 6 between the reservoir 4 and the cylinder 5. A valve 7, both the valve 6 and 7 may be needle valves, lead to a reactor 8. Downstream of the reactor 8 is a two micron filter 9 which leads to another needle valve 10. A vacuum pump 11 is connected to the system by means of a two-way valve 12 and a hydrogen desorption volume measurement set-up 13 is connected through the two-way valve 12 to the rest of the system 20.

That setup 20 was tested for leaks under vacuum, as well as under moderately high pressure, before hydrogen adsorption experiments took place. The system between valve 6 and valve 10, which was fully under vacuum 2 hours or put into a load of about 10 MPa, was left 24 hours to check if the pressure was kept constant.

The hydrogen uptake experiment was undertaken under ambient conditions of 297 K and moderately high pressure of 10 MPa, which are compatible in future applications for electric or hybrid vehicles. All carbon samples prepared from sepiolite were initially heated in a vacuum oven for 4 hours at 150° C. to remove absorbed water or any impurities. Three grams of the sample were introduced into the reactor. The whole setup 20 was fully vacuum-degassed for 2 hours. Then, H₂ was introduced into the hydrogen reservoir to a certain pressure (about 10 MPa). The H₂ adsorption starts by opening valve 7. The changes in pressure were monitored versus time and the data were corrected accordingly. The results for the H₂ adsorption in weight % were calculated from the real gas equation:

$$\begin{matrix}( {p}_{1} + {n}_{1}^{2} \frac{a}{{V}_{1}^{2}} ) ( {V}_{1} - {n}_{1} b ) = {n}_{1} {RT}_{1} & [ 1 ] \\ ( {p}_{2} + {n}_{2}^{2} \frac{a}{{( {V}_{1} + {V}_{2} )}^{2}} ) ( {V}_{1} + {V}_{2} - {n}_{2} b ) = {n}_{2} {RT}_{2} & [ 2 ]\end{matrix}$$

Where volume V₁ is the volume of hydrogen reservoir 4 and V₂ is the void volume of the reactor 8 reduced by the volume of the carbon sample itself, which is calculated from the carbon mass with a bulk skeleton density of 1900 kg/m³. Thus, the open pore volume is part of the volume V₂, and a normal compressed gas density inside the accessible pore volume gives no contribution to the measured adsorption. If there is no adsorption, n₂ will equal n₁. Only if adsorption takes place, i.e., the H₂ density surpasses vapor density at least locally, n₂ will be less than n,. Then, the difference between n₁ and n₂ equals the excess adsorption described by the nanofiber carbon.

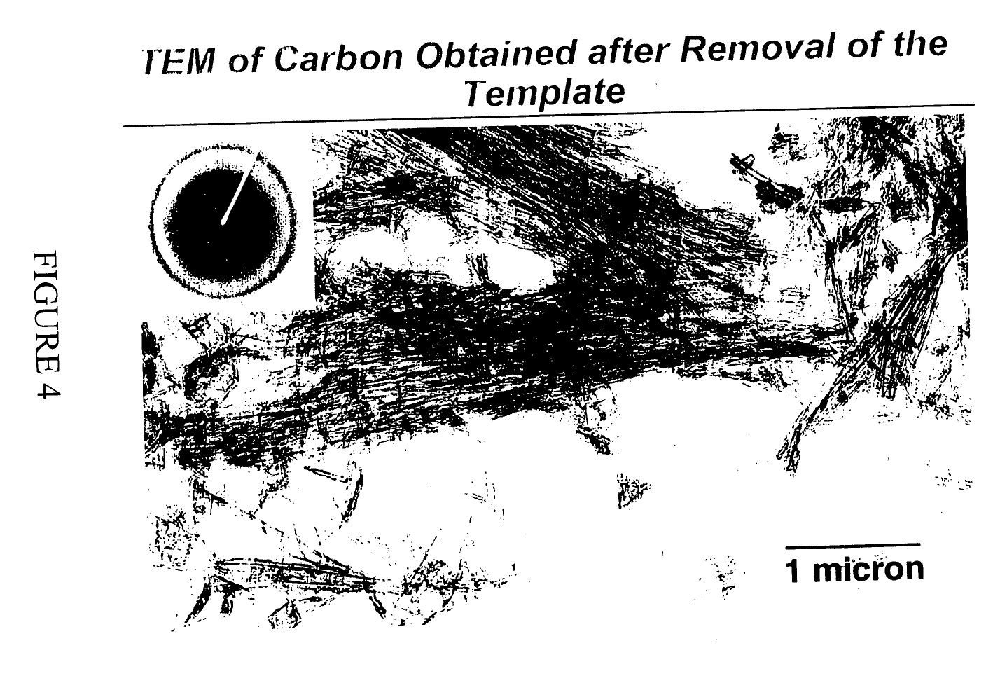

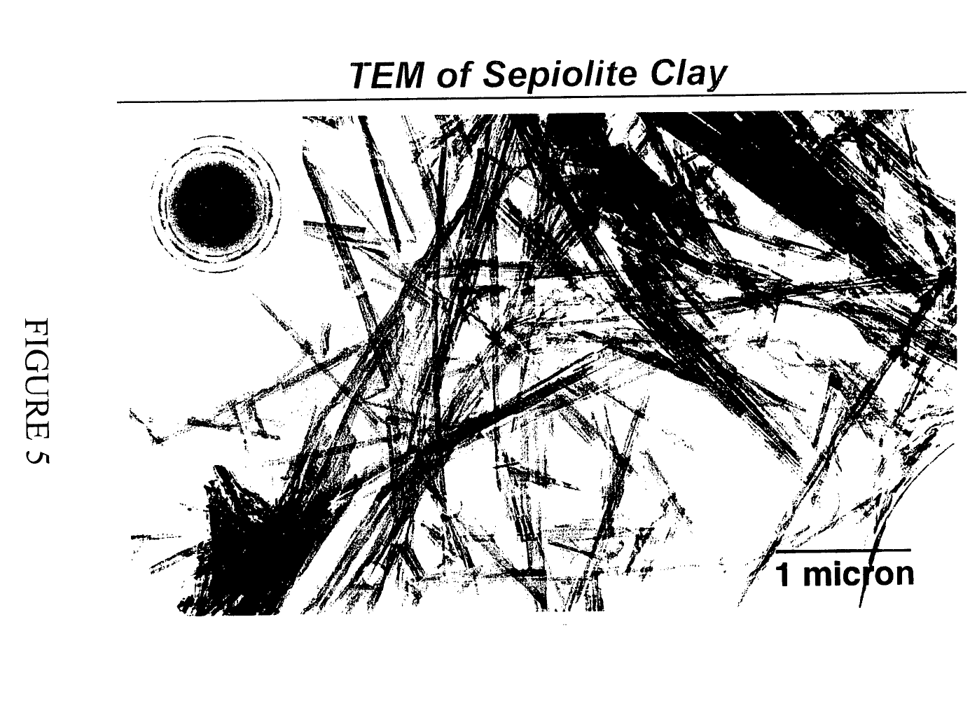

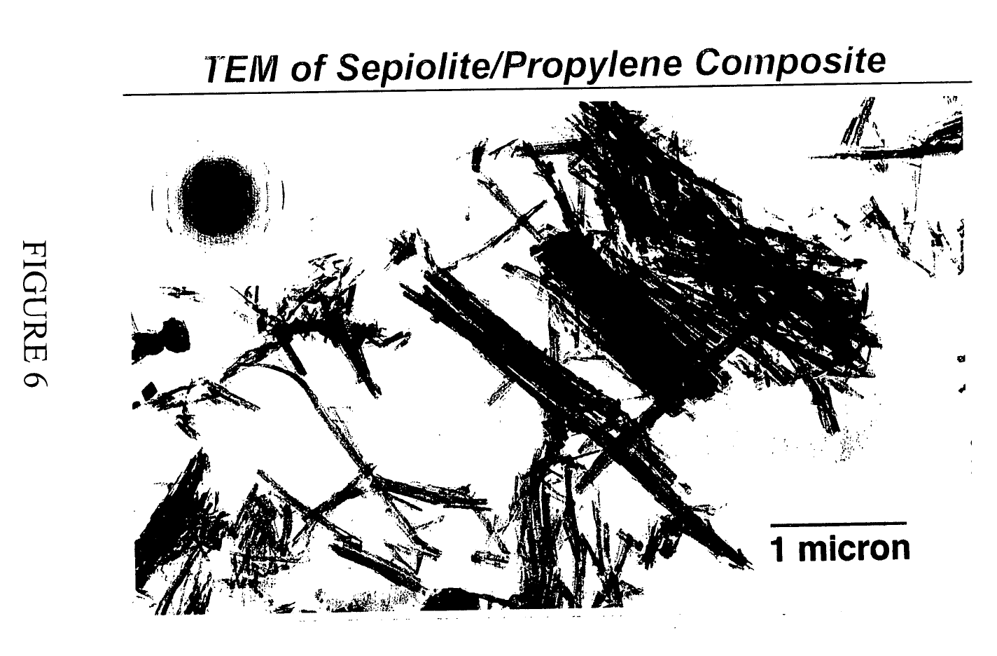

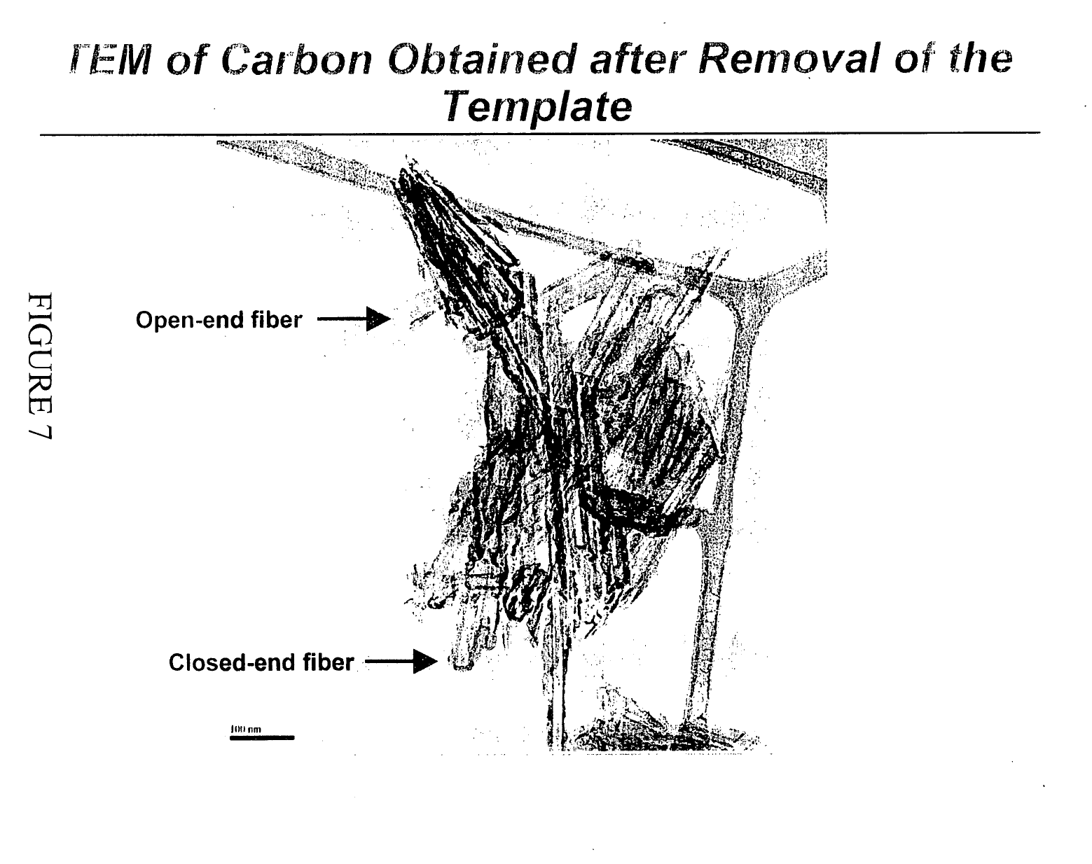

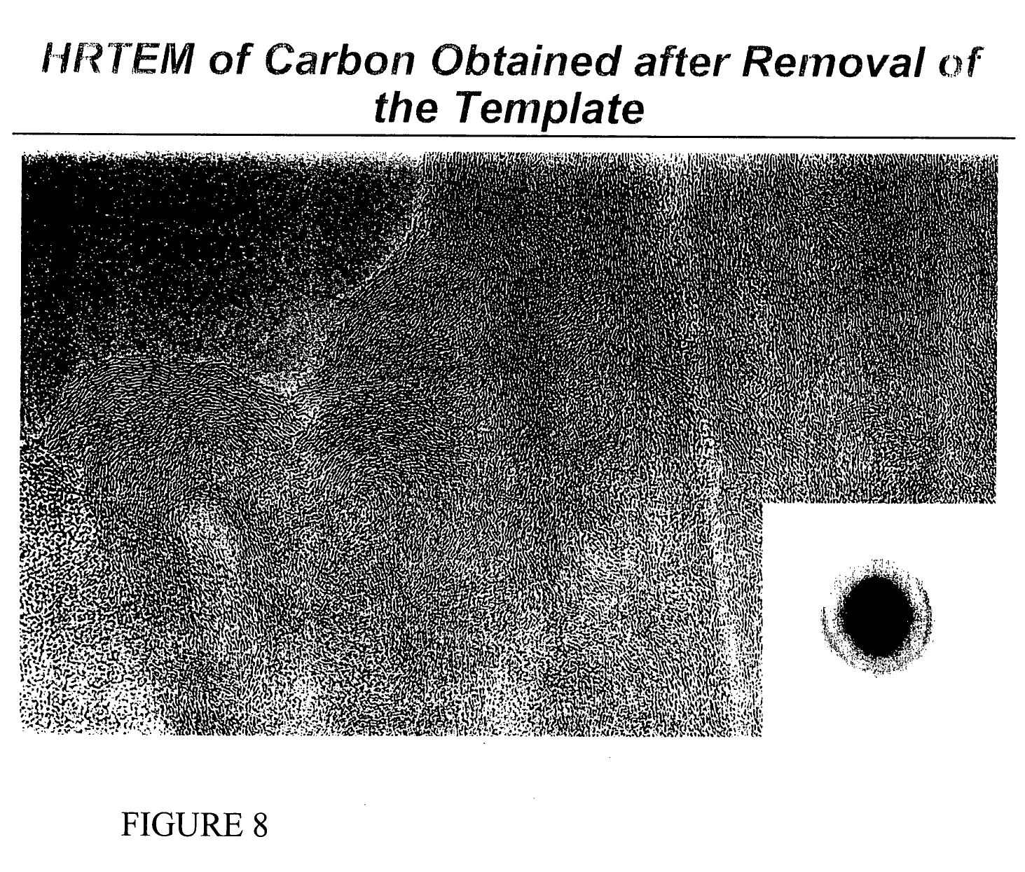

The results concerning XRD, TGA, N₂ BET, and low resolution TEM, are described in detail in the Sandi et al. paper. In brief, low resolution TEMs show that upon dissolution of the inorganic matrix, carbon fibers (1-1.5 microns long) are obtained (FIG. 4) whose orientation and shape resemble that of the original clay (FIG. 5). A TEM (FIG. 6) of the sepiolite/propylene composite shows the nature of the fibers before the matrix and FIG. 7 shows another view of the carbon fibers. The small area electron diffraction (SAED) pattern of the carbon fibers shows diffuse rings typical of amorphous carbon. By using high resolution TEM (FIG. 8), we observed the typical structure exhibited by multi-wall nanofibers.

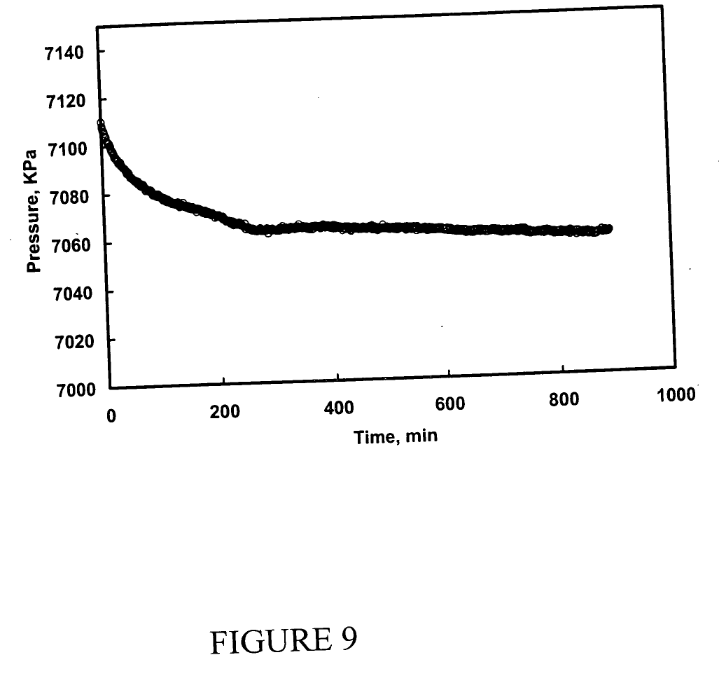

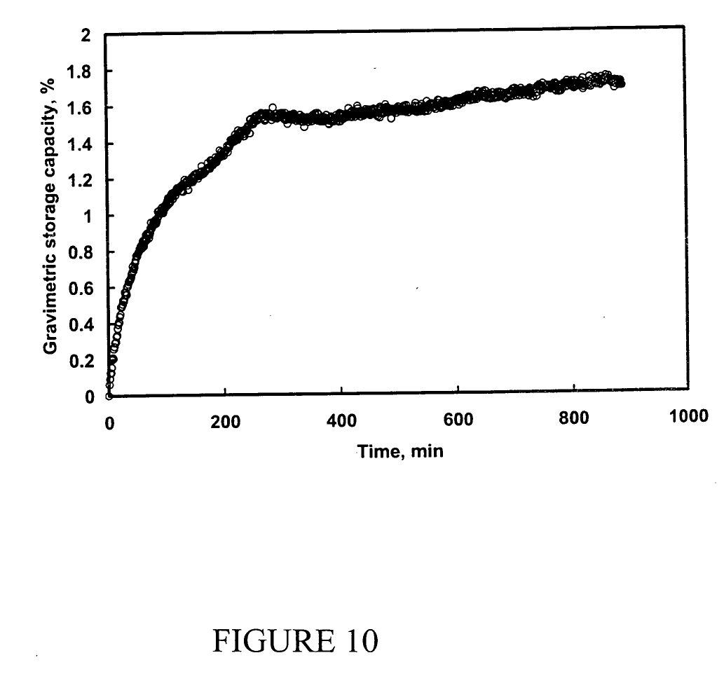

Hydrogen uptake/release experiments were conducted on the carbon nanofiber samples contained in a stainless steel vessel. Prior to introducing the samples, they were evacuated and heated to 230° C. in order to remove gases that might be chemisorbed on the edges of the carbon samples. FIG. 9 shows the pressure transition for the “fraction 3” sample after the introduction of hydrogen into the reactor chamber. The adsorption rate decreases after 260 min. At that time, ˜94% of the whole adsorption capacity is achieved. FIG. 10 shows the amount of H₂ in weight percent for that carbon sample.

The H₂ storage capacities for six different samples from highest to lowest are: 2nd>3 rd>raw>4th>1st>Spanish sample, as listed in Table I. Hydrogen molecules are physisorbed at the exterior surfaces of the nanofiber carbon by van der Waals forces, as well as interstitial spaces by capillary forces. Compared to the other carbon samples, “fraction 2” has the largest surface area and smallest average pore diameter, which might be a factor for the highest H₂ storage ability. The relationship between BET surface area and H₂ storage ability will be exploited further. Considering that the uptake and release experiments were carried out at room temperature and low pressures, the carbon nanofibers perform well for storing hydrogen. Very recently, Rosi et al. reported the hydrogen storage ability of metalorganic frames (MOF). They have found that a MOF stores 4.5 weight percent hydrogen at 78 K, but only 1.0 weight percent at room temperature. An additional advantage of the nanofibers compared to the MOF is the fact that the volumetric density of the fibers is ten times larger than the MOF, which means that in practical applications, a smaller storage compartment can be used. We believe that the sepiolite-derived nanofibers will increase the hydrogen storage ability by a factor of 3 or higher at lower temperatures. On the other hand, the H₂ desorption hysteresis in all the samples at ambient pressure and temperature suggests that the adsorbed H₂ need some energy to be released from the carbon matrix.

While the invention has been particularly shown and described with reference to a preferred embodiment hereof, it will be understood by those skilled in the art that several changes in form and detail may be made without departing from the spirit and scope of the invention.

The embodiments of the invention in which an exclusive property or privilege is claimed are defined as follows:

1. Carbonaceous nanofibers derived from a one dimensional channeled material having hydrogen adsorbed on the surfaces thereof.

2. The carbonaceous nanofibers of claim 1, wherein said one dimensional material is synthetic.

3. The carbonaceous nanofibers of claim 1, wherein said one dimensional material is one or more of an aluminosilicate or an aluminophosphate or a magnesium silicate or phosphate.

4. The carbonaceous nanofibers of claim 3, wherein said one dimensional material is a zeolite.

5. The carbonaceous nanofibers of claim 1, wherein said one dimensional material is a clay.

6. The carbonaceous nanofibers of claim 5, wherein said clay is one or more of sepiolite or imogolite or palygorskite.

7. The carbonaceous nanofibers of claim 6, wherein said clay has a (BET) surface area greater than about 200 m²/gm.

8. The carbonaceous nanofibers of claim 6, wherein said clay has a (BET) surface area of about 245 m²/gm.

9. The carbonaceous nanofibers of claim 1, wherein said carbonaceous nanofibers have hydrogen adsorbed thereon not less than about 4% by weight of said carbonaceous nanofibers at ambient temperatures.

10. The carbonaceous nanofibers of claim 1, wherein said carbonaceous nanofibers are cylindrical and/or polyhedrons.

11. A method of storing hydrogen, comprising providing a plurality of carbonaceous nanofibers derived from a one dimensional channeled material, and contacting the nanofibers with hydrogen at a temperature and pressure for a time sufficient to adsorb hydrogen thereon.

12. The method of claim 11, wherein the one dimensional channeled material is contacted with ethylene and/or polypropylene vapor and heated to a temperature sufficient to polymerize the hydrocarbon vapor and thereafter removing the material leaving carbonaceous nanofibers.

13. The method of claim 12, wherein the material is a clay and is removed with hydrofluoric acid.

14. The method of claim 11, wherein the nanofibers are cylindrical and/or polyhedrons.

15. The method of claim 11, wherein the polymerization occurs at a temperature of about 700EC.

16. The method of claim 11, wherein hydrogen is contacted with the nanofibers at a temperature and a pressure for a time sufficient to adsorb hydrogen in an amount greater than about 4% by weight of the nanofibers.

17. The method of claim 11, wherein the one dimensional channeled material is one or more of a synthetic or naturally occurring material having acid sites within the channels.

18. The method of claim 17, wherein the one dimensional channeled material is contacted with a hydrocarbon vapor at a temperature and pressure and for a time sufficient to polymerize the hydrocarbon vapor in the channels and thereafter pyrolyzing the polymerized material in the channels to form the nanofibers.

19. The method of claim 18, wherein the hydrocarbon vapor is diluted with a nonreactive gas.

20. The method of claim 19, wherein the non-reactive gas is nitrogen.
